(19) United States
(12) Patent Application Publication
(10) Pub. No.: US 2026/0038460 A1
(43) Pub. Date: Feb. 5, 2026

(54) METHOD FOR INCREASING THE LIFETIME OF A DISPLAY, RELATED DISPLAY, COMPUTER PROGRAM AND DEVICES

(71) Applicant: Mettler-Toledo (Albstadt) GmbH, Albstadt (DE)

(72) Inventors: Janik Quarleiter, Stetten a.k.M. (DE); Edgar Kempf, Inzigkofen (DE)

(21) Appl. No.: 19/286,620

(22) Filed: Jul. 31, 2025

(30) Foreign Application Priority Data
Jul. 31, 2024 (EP) 24191927.3

(51) Int. Cl. G09G 5/10

(52) U.S. Cl. CPC G09G 5/10; G09G 2320/041; G09G 2320/043; G09G 2320/0626

(57) ABSTRACT

The invention relates to the field of displays (monitors, terminals) used in retail, industry, logistics, transportation and laboratory, in particular displays for retail weighing devices. A method for increasing the lifetime of such displays is provided. The method includes setting a brightness dimming parameter of the display to an initial value that is below a possible maximum value, determining whether a parameter that is characteristic for an aging of the display reached a threshold value, and increasing the brightness dimming parameter if the parameter that is characteristic for an aging of the display reached the threshold value. Further provided are a corresponding display, computer program, and retail, industry, logistics, transportation and laboratory devices, in particular a corresponding retail weighing device.

### CROSS-REFERENCE TO RELATED APPLICATIONS

This application claims the benefit of European Patent Application No. 24191927.3 filed Jul. 31, 2024, the disclosures of which are hereby incorporated by reference as if fully restated herein.

### TECHNICAL FIELD

The invention relates to the field of displays (monitors, terminals) used in retail, industry, logistics, transportation and laboratory, in particular displays for weighing devices, product inspection devices, dimension and/or volume determination devices, counting devices, monitoring devices etc., in particular displays for weighing devices used in retail. The invention relates to a method for increasing the lifetime of such displays, as well as to corresponding displays, computer programs and devices, such as weighing devices, product inspection devices, dimension and/or volume determination devices, counting devices, monitoring devices etc., in particular retail weighing devices.

### BACKGROUND AND SUMMARY OF THE INVENTION

Displays used in retail, industry, logistics, transportation and laboratory, this means displays that are in use an integral part of a device used in retail, industry, logistics, transportation, and laboratory, age quite quickly because they are usually in an on state for hours every day, independent of whether there is an actual use or not. This is in particular true if the display is used in retail.

In particular when used in retail, the displays age very quickly. This is because they are not only in their on-state for long days or even permanently, but also operated with high brightness. In retail, the displays are usually used in the shopping area, this means a well lit area. Further, the displays must provide any price-relevant information to a customer in a sufficient clear, this also includes sufficiently bright, manner for being legal-for-trade, this means for being in agreement with regulatory requirements and, hence, being approved by a competent authority or conformity assessment body for use in retail.

The lifetime of a display, in particular a display used in a retail, for example in a retail weighing device, may be and usually is defined as the operating time that may pass until the display brightness has decreased from an initial maximal brightness to 50% of this initial maximal brightness. For example, the nominal lifetime of a TFT-LED display used for a retail weighing device may be 15′000 or 30′000 hours, wherein “nominal” indicates that this lifetime is true only if the display is run under specific conditions. The effective lifetime may differ, in particular decrease, significantly from the nominal lifetime if the display is run under conditions that differ from the specific conditions. In particular, the display temperature and the used display brightness, the latter influences also the display temperature, may cause a significant deviation from the nominal lifetime if not in agreement with the specific conditions. The inventors observed effective lifetimes that were half of the nominal lifetimes or even less. Even in regions with moderate climate conditions and/or widespread use of air conditioning, significant lifetime reductions were observed.

Actually, the mentioned lifetime reductions seem to be accepted as a fact that cannot be changed. Reasons for this may be the high cost-sensitivity during acquisition of the devices into which the displays are integrated, space and handling requirements, legal requirements (in particular in case of displays used for retail weighing devices, as mentioned above), etc.

It is an insight of the invention that the effective lifetime of a display can be increased significantly and without adversely affecting the user experience, failing to fulfill legal requirements, or causing further costs by applying an active and automated display dimming.

Display dimming is known and used with respect to state-of-the-art displays used in retail, industry, logistic, transportation or laboratory. However, this dimming is not used, or at least not specifically designed for increasing the lifetime of the display. For example, U.S. Pat. No. 6,536,658B1 and WO 2015/038365A2 disclose dimming in dependence on a user presence. CN 211555034U is an example of a document that discloses dimming in dependence on ambient brightness.

It is an object of the invention to provide a method for increasing the lifetime of a display used in retail, industry, logistic, transportation or laboratory, this means a display that is used in a retail, industry, logistic, or laboratory device and that is usually operated with a switched on, in particular bright, screen over long days.

In particular, it is an object of the invention to provide a method for increasing the lifetime of a display used in retail, industry, logistic, transportation or laboratory that may be implemented in existing displays, is low-cost, does not need any contribution from a display user or owner, and does not affect adversely the user experience.

In particular, it is an object of the invention to provide a method for increasing the lifetime of a display used in retail, industry, logistic, transportation or laboratory that implements active, in particular automated, display dimming that is advantageous with respect to lifetime, consistent display brightness over time and, to some extend at least, reduced power consumption.

It is a further object of the invention to provide a related computer program, a related display and a related retail, industry, logistics, transportation or laboratory device, in particular a related retail weighing device.

At least one of these objects is achieved by the claimed method, devices, and computer programs.

The provided method for increasing the lifetime of a display used in retail, industry, logistic, transportation or laboratory comprises the following steps:
A step of setting a brightness dimming parameter of the display to an initial value that is below a possible maximum value of the brightness dimming parameter, wherein the step of setting a brightness dimming parameter of the display to an initial value is carried out at the beginning of the operating time, this means at the beginning of the lifetime, of the display. For example, the step of setting a brightness dimming parameter of the display to an initial value is carried out by the manufacturer or provider of the device before the device is delivered, by the manufacturer or provider of a device into which the display is integrated before the device is delivered, or at the user's site when the display or device is installed.
Any parameter, in particular operating parameter of the display, on which an actual brightness of the display (more precisely the screen of the display) depends and via which the actual brightness of the display may be adjusted may be considered as a brightness dimming parameter. Most displays provide such a brightness dimming parameter in an obvious manner for enabling a user to dim the brightness.
The initial value may be such that the brightness of the display is sufficient, but not significantly higher, for satisfying the user's needs, for fulfilling regulatory requirements (if any), for being a good starting point for further, in particular automated, brightness adjustments (if any, e.g., adaption to changing ambient brightness, adaption in dependence on user presence detection, adaption in dependence on time of the day etc.). For example, the initial value may be in the range of 50 to 95% of the possible maximum value, in particular in the range of 50 to 90%, 50 and 85%, or 60 and 85%. The initial value may depend on at least one of the display type (technology, quality etc.) and the ambient conditions, in particular ambient brightness condition, under which it will be operated.
A step of determining whether a parameter that is characteristic for an aging of the display reached a threshold value.
A measured display brightness, a calculated display brightness, an actual operating time, an effective operating time derived from the actual operating time, a display current, a current consumption of the display, a resistance of the display, and a power consumption of the display are examples of a parameter that is characteristic for an aging of the display. The threshold value may be set such that a display brightness that may no longer satisfy the user's needs, fulfil regulatory requirements (if any), be a good starting point for further, in particular automated, brightness adjustments etc. is detected.
A step of increasing the brightness dimming parameter if the parameter that is characteristic for an aging of the display reached the threshold value.
In particular, the brightness dimming parameter is increased in the step of increasing the brightness dimming parameter to compensate for a darkening of the display due to aging.
In particular, the brightness dimming parameter may be increased such that the resulting display brightness is certain to satisfy (again, as the case may be) the user's needs, to fulfil (again) regulatory requirements (if any), to be (again) a good starting point for further, in particular automated, brightness adjustments etc.
For example, the brightness dimming parameter may be increased such that the resulting display brightness corresponds again to the display brightness associated with the initial value at the time of its setting.
The amount by which the brightness dimming parameter is increased may base on experience or, in case a display brightness sensor is available, on a feedback loop including the output of the brightness sensor. In case the amount by which the brightness dimming parameter is increased bases on experience, at least one value that represents the amount may be provided, in particular by the manufacturer or provider of the display, or by the manufacturer or provider of a device into which the display is integrated.
Preferably, the step of increasing the brightness dimming parameter if the parameter that is characteristic for an aging of the display reached the threshold value is an automated step. In other words, the method may comprise a step of increasing automatically the brightness dimming parameter if the parameter that is characteristic for an aging of the display reached the threshold value. However, it is conceivable to perform the step of increasing the brightness dimming parameter manually, for example in reaction to a hint or message provided to a user or employee.

The provided method for increasing the lifetime of a display used in retail, industry, logistic, transportation or laboratory may be a computer-implemented method, in particular if the step of increasing the brightness dimming parameter if the parameter that is characteristic for an aging of the display reached the threshold value is an automated step.

As indicated above, a display used in retail, industry, logistic, transportation or laboratory is a display that is designed for use in a retail, industry, logistic, transportation or laboratory device. Therefore, the display is usually equipped for being mounted to or integrated in a retail, industry, logistic, transportation or laboratory device, such as weighing devices, product inspection devices, dimension and/or volume determination devices, counting devices, monitoring device etc. In particular, the display may comprise industrial-grade fastening means, such as bores for display holding mechanisms (holding arms, holding rods etc.), holes for screws etc. The display, in particular its screen, has usually a diagonal that is more than 7 inches, for example more than 8, 9, 10, 11 or 12 inches. The display, in particular its screen, has usually a diagonal that is less than 17 inches. In particular, the diagonal may be between 7 and 17, 8 and 17, 9 and 17, 10 and 17, 11 and 17, or 12 and 17 inches. In particular, the diagonal may be around 8, 10, 12, 15 or 17 inches. In embodiment, the display has a weight of more than 300 g, 400 g or 500 g. The rather high weight of the display may be caused by a display housing that makes the display suitable for application in retail, industry, logistic, transportation or laboratory.

In an embodiment, the display is a display for a retail weighing device, in particular a retail weighing device used for selling products by weight.

Usually, the step of determining whether the parameter that is characteristic for an aging of the display reached a threshold value and the step of increasing (automatically, as the case may be) the brightness dimming parameter if the parameter that is characteristic for an aging of the display reached the threshold value are carried out more than once.

Therefore, according to an embodiment, the step of increasing the brightness dimming parameter is carried out whenever the parameter that is characteristic for an aging of the display reached the threshold value or a further threshold value.

In addition, the step of increasing the brightness dimming parameter may be carried out whenever the parameter that is characteristic for an aging of the display reached the threshold value or a further threshold value until the brightness dimming parameter equals the possible maximum value.

In embodiments in which there is a further threshold value, the further threshold value may be, and usually is, considered in a further step of determining whether the parameter that is characteristic for an aging of the display reached a threshold value, wherein the threshold value against which the parameter that is characteristic for an aging of the display is checked is in this further step the further threshold value. In addition, this further step is usually carried out after a corresponding step in which it was determined that the parameter that is characteristic for an aging of the display reached the “initial” threshold value, and, hence, after the step of increasing the brightness dimming parameter triggered thereby.

In particular, there may be a sequence of threshold values. In such embodiments, it may be determined whether the parameter that is characteristic for an aging of the display reached the first threshold value of the sequence of threshold values during a first phase of the method. As soon as it is determined that the parameter that is characteristic for an aging of the display reached the first threshold value, the brightness dimming parameter is increased and the first phase of the method ends. Then, it may be determined whether the parameter that is characteristic for an aging of the display reached the second threshold value of the sequence of threshold values during a second phase of the method. As soon as it is determined that the parameter that is characteristic for an aging of the display reached the second threshold value, the brightness dimming parameter is further increased and the second phase of the method ends. Then, the same procedure goes on with the third threshold value in a third phase of the method, the fourth threshold value in a fourth phase of the method and so on, until the brightness dimming parameter equals the possible maximum value.

A parameter that is characteristic for an aging of the display being an actual or effective operating time, and a sequence of threshold values comprising or consisting of actual or effective operating times at which the brightness dimming parameter shall be increased correspond to a vivid example of the embodiment disclosed in the preceding paragraph.

Independent of whether there is one threshold value only or a plurality, for example a sequence, of threshold values, the initial value of the brightness dimming parameter, the amount by which the brightness dimming parameter may be increased in a step of increasing the brightness dimming parameter and, as the case may be, the threshold value(s) may be selected such that little further aging of the display causes another increase of the brightness dimming parameter. Such a configuration is favorable with respect to lifetime, consistent display brightness over time, and power consumption because the display brightness is fine-tuned to a constant brightness and the display is run permanently with a brightness dimming parameter that is close to the lowest brightness dimming parameter that is assumed to provide a good display brightness, for example with respect to satisfying user's needs, fulfilling regulatory requirements (if any), being a good starting point for further, in particular automated, brightness adjustments, etc.

For example, the initial value of the brightness dimming parameter, the amount by which the brightness dimming parameter may be increased in a step of increasing the brightness dimming parameter and, as the case may be, the threshold value(s) may be selected such that a decrease in display brightness due to aging of 15% or less, in particular of 10% or less, 5% or less, 4% or less, 3% or less, 2% or less, or 1% or less triggers an increase of the brightness dimming parameter. A lower limit of a decrease in display brightness for triggering an increase of the brightness dimming parameter may be around 1%, 0.5%, 0.1%, 0.05% or 0.01%. However, as mentioned before, the lower limit of decrease in brightness for triggering an increase of the brightness dimming parameter may be such that the display brightness is fine-tuned to a constant brightness, in particular fine-tuned in a manner that there is an approximately stepless adaption of the brightness dimming parameter, in embodiments.

As mentioned above, a measured display brightness, a calculated display brightness, an actual operating time, and an effective operating time derived from the actual operating time are examples of a parameter that is characteristic for an aging of the display.

In an embodiment, the parameter that is characteristic for an aging of the display represents a brightness of the display, wherein this parameter is derived from an output of a brightness sensor. In this embodiment, the threshold value (threshold values, as the case may be) may be a set brightness value (set brightness values, as the case may be), and the step of increasing the brightness dimming parameter may be carried out if (whenever, as the case may be) the parameter that represents a brightness of the display reaches, this means equals or has passed, the set brightness value (a set brightness value, as the case may be).

It goes without saying that the brightness sensor is arranged, in particular arranged around the display, such that it is able to generate an output signal that is representative for the brightness of the display and/or from with a parameter can be derived that is representative for the brightness of the display. In addition, the display may be operated from time to time with set operating parameters, in particular with a set display dimming parameter, for generating a series of output signals that allow to monitor the effect of aging on display brightness and, as the case may be, for setting an increased display dimming parameter. The set operating parameters may comprise further displaying a specific color, color distribution or pattern, at least in the region of the display that determines the output of the brightness sensor.

For example, there may be one threshold value only, and the step of increasing the brightness dimming parameter may be carried out whenever the parameter that represents the brightness of the display and that is derived from an output of the brightness sensor when the display is run with actual set operating parameters reaches the threshold value. After an increase of the brightness dimming parameter, the actual set operating parameters may be updated, in particular by considering the increased brightness dimming parameter. For example, the step of increasing the brightness dimming parameter may be carried out when the parameter that represents the brightness of the display and that is derived from an output of the brightness sensor when the display is run with first set operating parameters reaches the threshold value. After an increase of the brightness dimming parameter, the first set operating parameters may be updated to second set operating parameters and a second step of increasing the brightness dimming parameter may be carried out whenever the parameter that represents the brightness of the display and that is derived from an output of the brightness sensor when the display is run with the second set operating parameters reaches the threshold value. This procedure may then go on with third, fourth . . . set operating parameters and a third, fourth . . . step of increasing the brightness dimming parameter until the possible maximum value of the brightness dimming parameter is reached.

According to another example, the parameter that is characteristic for an aging of the display may represent a remaining maximum brightness of the display. The threshold value may then be a set remaining maximum brightness value, and the step of increasing (automatically, as the case may be) the brightness dimming parameter may be carried out if the parameter that represents the remaining maximum brightness of the display reaches, this means equals or has passed, the (next, as the case may be) set remaining maximum brightness value. An advantage of this embodiment is that the set operating parameters with which the display is run when the output of the brightness parameter from which the parameter that represents the brightness of the display is derived is generated do not need to be changed during implementation of the method for increasing the lifetime of the display. On the other hand, a sequence of threshold values needs to be determined for triggering steps of increasing the brightness dimming parameter at the right time.

In other words, the parameter that is characteristic for an aging of the display represents, in an embodiment, a remaining maximum brightness of the display, wherein this parameter is derived from an output of a brightness sensor. The threshold value (threshold values, as the case may be) may then be a set remaining maximum brightness value (values, as the case may be), and the step of increasing the brightness dimming parameter may be carried out if (whenever, as the case may be) the parameter that represents a remaining maximum brightness of the display brightness reaches, this means equals or has passed, the set remaining maximum brightness value (a set remaining maximum brightness value, as the case may be).

In an alternative embodiment, the parameter that is characteristic for an aging of the display is a calculated brightness value. The threshold value (threshold values, as the case may be) may be a set brightness value, (set brightness values, as the case may be) and the step of increasing the brightness dimming parameter may be carried out if (whenever, as the case may be) the calculated brightness value reaches, this means equals or has passed, the set brightness value (a set brightness value, as the case may be).

Similar to the examples given with respect to the embodiment in which the parameter that is characteristic for an aging of the display represents a brightness of the display, wherein this parameter is derived from an output of a brightness sensor, the calculated brightness value may represent an actual brightness of the display or a remaining maximum brightness of the display.

At least one of the following may be used for calculating the calculated brightness value:
The actual operating time (also called operation duration, operation time, uptime etc.), e.g., as determined by the display or its controller. The actual operating time may be not more than the total time (duration) the display, in particular its screen, was in an on-state, so far. The actual operating time may be received or retrieved by the controller on which the computer program is executed that calculates the calculated brightness value.
A characteristic for an operative temperature at which the display was operated so far. This characteristic may be derived from at least one of an output of a temperature sensor, e.g., as disclosed further below, an operation parameter of the display, such as the brightness dimming parameter, an output from a brightness sensor, e.g., as disclosed above, and/or any other parameter that is indicative for the operative temperature of the display, such as its power consumption, a resistance of the display, a current of the display etc.
A characteristic for a brightness at which the display was operated so far. This characteristic may be derived from at least one of an output of a brightness sensor, e.g., as disclosed above, and/or an operation parameter of the display, such as the brightness dimming parameter, an output of a temperature sensor, e.g., as disclosed further below, and/or any other parameter that is indicative for the brightness at which the display was operated, such as its power consumption, a resistance of the display, a current of the display etc.

For example, at least the actual operating time and a characteristic for an operative temperature at which the display was operated so far may be used for calculating the calculated brightness value. The calculation may base further on knowledge about the dependence of display brightness on operating time and operative temperature of the used display. The characteristic for an operative temperature may be derived from an output of a temperature sensor.

For example, a characteristic for an operative temperature at which the display was operated during its operation may be used for calculating the calculated brightness value, wherein the characteristic for an operative temperature is determined by monitoring an output of a temperature sensor, wherein the output of the temperature sensor is characteristic for the temperature at which the display is operated or wherein the output of the temperature sensor is processed for generating a processed output that is characteristic for the temperature at which the display is operated.

The former (output of the temperature sensor is characteristic directly for the temperature at which the display is operated) may apply in configurations in which the temperature sensor is arranged at or in the display housing, in particular close to the display or, in the case of a display comprising a backlight, in particular an LED backlight, close to the backlight LED.

The latter (output of the temperature sensor is processed for generating a processed output that is characteristic for the temperature at which the display is operated) may apply in configurations in which the temperature sensor is arrange remote from the display or, as the case may be, its backlight. Processing may comprise adding a predetermined temperature value that is representative for the specific configuration. Processing may consider a, in particular actual, characteristic for a brightness at which the display is operated, such as the brightness dimming parameter and/or the output of a brightness sensor, if any. Alternatively or in addition, processing may consider any other parameter that is indicative for the operative temperature of the display, such as its power consumption, a resistance of the display, a current of the display etc.

For example, alternatively or in addition to using a characteristic for an operative temperature at which the display was operated during its operation for calculating the calculated brightness value, wherein the characteristic for an operative temperature is determined by monitoring an output of a temperature sensor, a characteristic for a brightness at which the display was operated during its operation may be used for calculating the calculated brightness value, wherein the characteristic for a brightness is determined by at least one of monitoring the brightness dimming parameter and monitoring an output of a brightness sensor, wherein the output of the brightness sensor is characteristic for the brightness at which the display is operated. The brightness sensor may be according to any embodiment disclosed so far.

In an embodiment, the parameter that is characteristic for an aging of the display represents an actual operating time of the display. This embodiment may be, and usually is, alternative to the embodiment in which the parameter that is characteristic for an aging of the display represents a brightness of the display that is derived from an output of a brightness sensor, and alternative to the embodiment in which the parameter that is characteristic for an aging of the display is a calculated brightness value.

In this embodiment, the threshold value may be at least one set actual operating time, and the step of increasing the brightness dimming parameter may be carried out if the actual operating time reaches, this means equals or has passed, the set actual operating time.

In particular, as pointed out above, there may be a sequence of threshold values given by a sequence of set actual operating times, and the step of increasing the brightness dimming parameter may be carried out whenever the actual operating time reaches, this means equals or has passed, a set actual operating time of the sequence of set actual operating times.

As mentioned above, the actual operating time (also called operation duration, operation time, uptime etc.) may be determined by the display or its controller. It may be received, retrieved or read-out by any controller in communication with the display or its controller. The actual operating time may be not more than the total time (duration) the display, in particular its screen, was in an on-state, so far.

In an embodiment, the parameter that is characteristic for an aging of the display is a calculated effective operating time of the display. This embodiment may be, and usually is, alternative to the embodiment in which the parameter that is characteristic for an aging of the display represents a brightness of the display that is derived from an output of a brightness sensor, alternative to the embodiment in which the parameter that is characteristic for an aging of the display is a calculated brightness value, and alternative to the embodiment in which the parameter that is characteristic for an aging of the display represents an actual operating time of the display.

In this embodiment, the threshold value may be at least one set effective operating time, and the step of increasing the brightness dimming parameter may be carried out if the effective operating time reaches, this means equals or has passed, the set effective operating time.

In particular, as pointed out above, there may be a sequence of threshold values given by a sequence of set effective operating times, and the step of increasing the brightness dimming parameter may be carried out whenever the effective operating time reaches, this means equals or has passed, a set effective operating time of the sequence of set effective operating times.

At least one of the following may be used for calculating the effective operating time:
The actual operating time (also called operation duration, operation time, uptime etc.), e.g., as determined by the display or its controller. The actual operating time may be not more than the total time (duration) the display, in particular its screen, was in an on-state, so far. The actual operating time may be received or retrieved by the controller on which the computer program is executed that calculates the effective operating time.
A characteristic for an operative temperature at which the display was operated so far. This characteristic may be derived from at least one of an output of a temperature sensor, e.g., as disclosed above, an operation parameter of the display, such as the brightness dimming parameter, an output from a brightness sensor, e.g., as disclosed above, and/or any other parameter that is indicative for the operative temperature of the display, such as its power consumption, a resistance of the display, a current of the display etc.
A characteristic for a brightness at which the display was operated so far. This characteristic may be derived from at least one of an output of a brightness sensor, e.g., as disclosed above, and/or an operation parameter of the display, such as the brightness dimming parameter, an output of a temperature sensor, e.g., as disclosed further below, and/or any other parameter that is indicative for the brightness at which the display was operated, such as its power consumption, a resistance of the display, a current of the display etc.

For example, at least the actual operating time and a characteristic for an operative temperature at which the display was operated so far may be used for calculating the effective operating time. The calculation may base further on knowledge about how display temperature, in particular a temperature difference relative to the specific temperature under which the nominal lifetime of the display is determined, influences display lifetime. The characteristic for an operative temperature may be derived from an output of a temperature sensor.

For example, a characteristic for an operative temperature at which the display was operated during its operation may be used for calculating the effective operating time, wherein the characteristic for an operative temperature is determined by monitoring an output of a temperature sensor, wherein the output of the temperature sensor is characteristic for the temperature at which the display is operated or wherein the output of the temperature sensor is processed for generating a processed output that is characteristic for the temperature at which the display is operated.

Again, the former (output of the temperature sensor is characteristic directly for the temperature at which the display is operated) may apply in configurations in which the temperature sensor is arranged at or in the display housing, in particular close to the display or, in the case of a display comprising a backlight, in particular an LED backlight, close to the backlight LED.

The latter (output of the temperature sensor is processed for generating a processed output that is characteristic for the temperature at which the display is operated) may apply in configurations in which the temperature sensor is arrange remote from the display or, as the case may be, its backlight. Processing may comprise adding a predetermined temperature value that is representative for the specific configuration. Processing may consider a, in particular actual, characteristic for a brightness at which the display is operated, such as the brightness dimming parameter and/or the output of a brightness sensor, if any. Alternatively or in addition, processing may consider any other parameter that is indicative for the operative temperature of the display, such as its power consumption, a resistance of the display, a current of the display etc.

For example, alternatively or in addition to using a characteristic for an operative temperature at which the display was operated during its operation for calculating the calculated brightness value, wherein the characteristic for an operative temperature is determined by monitoring an output of a temperature sensor, a characteristic for a brightness at which the display was operated during its operation may be used for calculating the effective operating time, wherein the characteristic for a brightness is determined by at least one of monitoring the brightness dimming parameter and monitoring an output of a brightness sensor, wherein the output of the brightness sensor is characteristic for the brightness at which the display is operated. The brightness sensor may be according to any embodiment disclosed so far.

In any embodiment of the method disclosed so far, the display, or the device into which it is integrated, may be configured for at least one of:
Detecting a user presence and adjusting, in particular adjusting automatically, the brightness dimming parameter in dependence on the presence or absence of a user.
Detecting an ambient brightness and adjusting, in particular adjusting automatically, the brightness dimming parameter in dependence on the detected ambient brightness.
Monitoring the time of the day and adjusting, in particular adjusting automatically, the brightness dimming parameter in dependence on the time of the day.

If at least one of these brightness dimming parameter adjustment methods is realized, the brightness dimming parameter set in the step of setting a brightness dimming parameter of the display to an initial value and the brightness dimming parameter(s) as increased to in the step(s) of increasing (automatically, as the case may be) the brightness dimming parameter may be considered as basic brightness dimming parameters. It is then the basic brightness dimming parameter that is valid at the time a brightness adjustment due to ambient brightness, user presence and/or time of the day occurs that is adjusted.

As mentioned above, the display may be operated from time to time with set operating parameters, in particular with a set display dimming parameter, for generating a series of output signals that allow to monitor the effect of aging, in particular on display brightness, and, as the case may be, for setting an increased display dimming parameter. Thereby, an influence of anyone of the mentioned brightness dimming parameter adjustment methods on aging monitoring and, as the case may be, during setting the increased display dimming parameter, can be ruled out.

The invention provides further a display for use in retail, industry, logistic, transportation or laboratory, wherein the display is configured to be operated according to a method for increasing the lifetime of a display according to any embodiment disclosed. In particular, the display comprises a controller or is configured to connect to a controller, wherein the controller is configured to execute a computer program comprising instructions, which, when the computer program is executed by the controller, cause the display to be operated according to the method according to any embodiment disclosed. The computer program may be stored on a memory to which the controller has access. The memory may be a memory of the display, of the retail, industry, logistic, transportation or laboratory device into which the display is integrated, or a remote memory.

In particular, the display may allow for setting the brightness dimming parameter of the display to an initial value that is below a possible maximum value of the brightness dimming parameter, wherein the step of setting a brightness dimming parameter of the display to an initial value is carried out at the beginning of the operating time of the display. For example, the display may allow for setting the brightness dimming parameter when being in a service mode.

The display may be according to any embodiment disclosed with respect to the method for increasing the lifetime of a display. In particular, the display may comprise a temperature sensor and/or a brightness sensor according to any embodiment disclosed with respect to the method for increasing the lifetime of a display.

The invention provides further a retail, industry, logistic, transportation or laboratory device, in particular a retail weighing device, that is configured to be operated according to a method for increasing the lifetime of a display according to any embodiment disclosed. In particular, the device comprises a controller or is configured to connect to a controller, wherein the controller is configured to execute a computer program comprising instructions, which, when the computer program is executed by the controller, cause the device to be operated according to the method according to any embodiment disclosed. The computer program may be stored on a memory to which the controller has access. The memory may be a memory of the device, for example of the display, of the retail, industry, logistic, transportation or laboratory device into which the display is integrated, or a remote memory.

In particular, the retail, industry, logistic, transportation or laboratory device, in particular the retail weighing device, may comprising a display according to any embodiment provided by the invention.

In particular, the device may allow for setting the brightness dimming parameter of the display to an initial value that is below a possible maximum value of the brightness dimming parameter, wherein the step of setting a brightness dimming parameter of the display to an initial value is carried out at the beginning of the operating time of the display. For example, the device may allow for setting the brightness dimming parameter when being in a service mode.

The retail, industry, logistic, transportation or laboratory device may be according to any embodiment disclosed with respect to the method for increasing the lifetime of a display. In particular, the device may comprise a temperature sensor and/or a brightness sensor according to any embodiment disclosed with respect to the method for increasing the lifetime of a display.

The invention provides further a computer program comprising instructions which, when the computer program is executed by a controller (computer) that controls a display used in retail, industry, logistic, transportation or laboratory, cause the controller to allow for operating the display according to any disclosed embodiment of the method for increasing the lifetime of a display. In particular, the computer program, when executed by the controller, causes the display to be operated according to any disclosed embodiment of the method for increasing the lifetime of a display.

The invention provides further a reproducible computer-readable signal encoding the computer program that, when loaded and executed on a controller (computer) that controls a display used in retail, industry, logistic, transportation or laboratory, causes the controller to allow for operating the display according to any disclosed embodiment of the method for increasing the lifetime of a display. In particular, the encoded computer program, when loaded and executed on a controller (computer) that controls a display used in retail, industry, logistic, transportation or laboratory, causes the controller to operate the display according to any disclosed embodiment of the method for increasing the lifetime of a display.

The invention provides further a computer-readable medium having stored thereon instructions which, when executed by a controller (computer) that controls a display used in retail, industry, logistic, transportation or laboratory cause the controller to allow for operating the display according to any disclosed embodiment of the method for increasing the lifetime of a display. In particular, the stored instructions which, when executed by the controller cause the controller to operate the display according to any disclosed embodiment of the method for increasing the lifetime of a display.

The invention provides further a data carrier signal carrying instructions which, when executed by a controller (computer) that controls a display used in retail, industry, logistic, transportation or laboratory cause the controller to allow for operating the display according to any disclosed embodiment of the method for increasing the lifetime of a display. In particular, the carried instructions which, when executed by the controller cause the controller to operate the display according to any disclosed embodiment of the method for increasing the lifetime of a display.

The invention provides further a method for manufacturing a non-transitory computer readable medium, comprising the step of storing, on the computer readable medium, computer-executable instruction which, when executed by a processor of a display used in retail, industry, logistic, transportation or laboratory cause the display to perform the method for increasing the lifetime of a display according to any embodiment disclosed.

In particular, the controller, computer or processor mentioned with respect to the computer program, the reproducible computer-readable signal, the computer-readable medium, the data carrier signal, and the non-transitory computer readable medium causes the devices involved, such as the display, the temperature sensor (if any), the brightness sensor (if any), and, as the case may be, the retail, industry, logistic, transportation or laboratory device into which the display is integrated to carry out or to provide means for carrying out the steps of the method for increasing the lifetime of a display according to any embodiment disclosed.

It is understood that the features and embodiments disclosed above may be combined with each other. It will further be appreciated that further embodiments are conceivable within the scope of the present disclosure and the claimed subject matter which are obvious and apparent to the skilled person by virtue of the present disclosure.

### BRIEF DESCRIPTION OF THE DRAWINGS

The subject matter of the present disclosure is now to be explained in more detail by means of selected exemplary embodiments shown in the accompanying drawings. The figures show:

FIG. 1 A schematical representation of the main elements of a device in which an exemplary embodiment of a display according to the invention is integrated;

FIG. 2 An exemplary retail weighing device in which an exemplary embodiment of a display according to the invention is integrated;

FIG. 3 A visualization of what happens during execution of an exemplary embodiment of the method for increasing the lifetime of a display;

FIG. 4 A visualization of what happens during execution of another exemplary embodiment of the method for increasing the lifetime of a display;

FIG. 5 A visualization of what happens during execution of yet another exemplary embodiment of the method for increasing the lifetime of a display; and

FIG. 6 A flowchart of an exemplary embodiment of a method for increasing the lifetime of a display.

It is understood that the drawings are highly schematic, and details not required for instruction purposes may have been omitted for the ease of understanding and depiction. It is further understood that the drawings show only selected, illustrative embodiments, and embodiments not shown may still be well within the scope of the herein disclosed and/or claimed subject matter.

### DETAILED DESCRIPTION OF EXEMPLARY EMBODIMENT(S)

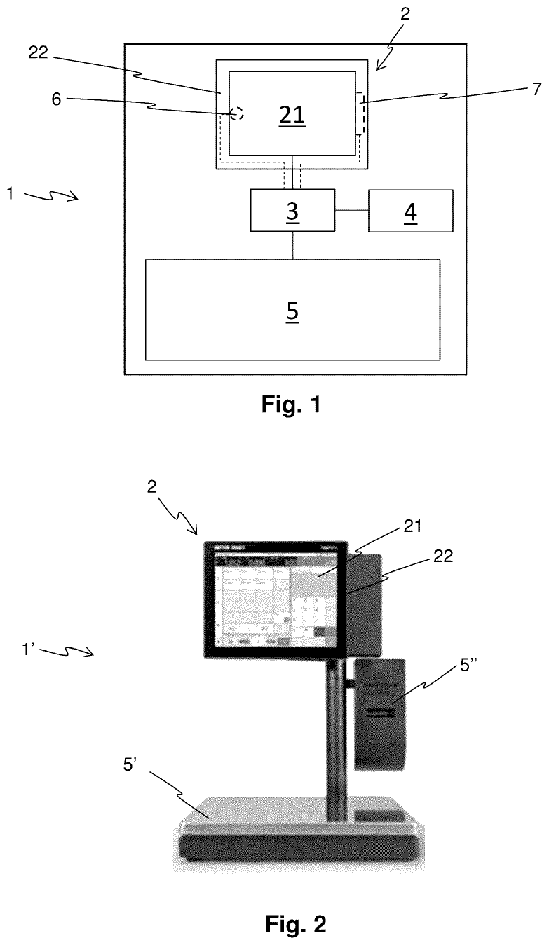

FIG. 1 shows schematically the main elements of a retail, industry, logistic, transportation or laboratory device 1 in which an exemplary embodiment of a display 2 according to the invention is integrated, this means a display 2 that is configured for carrying out a method according to the invention. The concrete configuration of the device 1, in particular the concrete main elements, depends on the embodiment of the method for which the device is configured. Elements that may be essential for one embodiment but optional or not needed for other embodiments are shown with dashed lines. Lines indicate exemplary communication connections between the elements shown in FIG. 1.

The retail, industry, logistic, transportation or laboratory device 1 comprises usually the components 5 needed for providing the device main functionality, such as weighing, product inspection, dimension and/or volume determination, counting etc. The device 1 comprises further a controller 3 and a memory 4. Usually, there are a plurality of controllers and/or a plurality of memories. The concrete device configuration is of low importance for carrying out the invention. Important is only that there is a controller 3 that is configured to control the display 2 and a memory 4 in connection with the controller, wherein a computer program is stored on the memory 4, this computer program comprising instructions which, when the computer program is executed by the controller 3, cause the display 2 to carry out a method according to the invention. This controller 3 or one of the controllers of the device 1 or connected with the device 1 may further be configured to carry out and/or contribute to further steps of a method according to the invention.

In dependence on the embodiment of the method, the controller 3 may monitor the output of a brightness sensor 6, monitor the output of a temperature sensor 7, and/or monitor, receive or retrieve at least one operation parameter of the display 2, such as an operating time 12, a brightness dimming parameter 10, a power consumption of the display 2, a resistance of the display 2, a current of the display 2 etc.

In dependence on the embodiment of the method, the computer program may comprise instructions which, when the computer program is executed by the controller 3, cause the controller to calculate at least one of a calculated brightness value of the display 2, in particular a calculated actual brightness value of the display, and a calculated effective operating time. This calculation or these calculations may use the monitored output of the brightness sensor 6, the monitored output of the temperature sensor 7 and/or the monitored, received or retrieved at least one operation parameter of the display 2. Thereby, the computer program may comprise further instructions which, when the computer program is executed by the controller 3, cause the controller to process at least one of the monitored, received or retrieved parameters or outputs. For example, the output of the temperature sensor 7 may be processed in dependence on the temperature sensor 7 position to provide a more accurate temperature of the display 2, or an operation parameter of the display 2 monitored, received or retrieved by the controller 3 may be processed for providing aging information in a more accurate manner.

In the exemplary embodiment shown in FIG. 1, the optional brightness sensor 6 is arranged on top and at an edge of the screen 21 of the display 2. A screen region covered by the brightness sensor 6 may be configured to show or to show from time to time a (same, as the case may be) color, color distribution or pattern that is at least one of suitable to determine a decrease in screen brightness due to aging and to monitor an actual screen brightness based on the output of the brightness sensor 6.

In embodiments in which the output of the brightness sensor 6 is used for determining an actual decrease in screen brightness due to aging and/or to set a new (basic, as the case may be) brightness dimming parameter after determination that there is need to run the display 2 with an adjusted, in particular increased, (basic) brightness dimming parameter (step 4), the screen 21 is usually operated with set operating parameters, in particular with a set brightness dimming parameter, any time the brightness sensor 6 is used for said determination of an actual decrease in screen brightness due to aging and/or for said setting of a new (basic) brightness dimming parameter. This is needed to undue possible operating parameters adjustments during normal use of the display 2, such as brightness dimming parameter adjustment by a user, by automated user presence detection, by automated screen brightness adaption due to ambient brightness, by time-of-the-day dependent automated screen brightness adaption etc.

In embodiments in which the output of the brightness sensor 6 is used for monitoring an actual screen brightness, for example for consideration in effective operating time calculation, the color, color distribution or pattern shown on the screen region covered by the brightness sensor 6 may be such that the output signal generated by the brightness sensor 6 is representative for an actual overall screen brightness.

In the exemplary embodiment shown in FIG. 1, the optional temperature sensor 7 is arranged in a housing 22 of the display 2 and close to the display screen 22. Ideally, the temperature sensor 7 is as close to the component of the display that is most responsible for display aging, for example the LED backlight in case the display is a TFT-LED display. However, as mentioned above, the computer program may consider a non-ideal position of the temperature sensor 7 by processing the output of the non-ideally positioned temperature sensor 7 for providing a more accurate actual temperature of the component of the display 2 that is most responsible for display aging. For example, the output of the temperature sensor 7 may be offset by a pre-set value. The temperature sensor 7 may be even arranged outside the housing 22, in particular if further information about the manner the display 2 is operated is available, such as at least one of the above-mentioned operation parameters of the display 2 that are monitored, received or retrieved by the controller 3 or an output of the optional brightness sensor 6.

The display 2 or the device 1 may be configured further to allow to set the brightness dimming parameter 10 to an initial value 13 that is below a possible maximum value 14. This setting may be done by the provider of the display 2 or the device 1 before providing it to the later user. Alternatively, it may be done during installation of the device 1 or the display 2 at its place of work. In this case, it may be done, for example, by a service technician under consideration of the working environment, in particular ambient brightness. In case of displays 2 or devices 1 that comprise a sensor for determining ambient brightness, for example for user presence detection, the setting may be done in an automated manner. In any case, the aim is to set the brightness dimming parameter 10 to an initial value 13 that causes a brightness of the screen 21 that is sufficient, but not significantly higher, for satisfying the user's needs, for fulfilling regulatory requirements (if any), and for being a good starting point for further, in particular automated, brightness adjustments (if any, e.g., adaption to changing ambient brightness).

In case there is any further brightness adjustment, in particular an automated brightness adjustment, via the brightness dimming parameter 10, the brightness dimming parameter 10 set (step S1) and increased (step S3) in agreement with the present invention may be considered as a basic brightness dimming parameter. An adjustment of the brightness dimming parameter 10 in dependence of ambient brightness, user presence, time of the day etc. are examples of further brightness adjustments.

The display 2 or the device 1 may be configured further to communicate an aging state of the display to a supervisor for triggering service actions.

FIG. 2 shows an exemplary retail weighing device 1′ as an example of the retail, industry, logistic, transportation or laboratory device 1. In this exemplary embodiment, the components 5 needed for providing the device main functionality, that is weighing a good and providing a price for the weighed good in a legal-for-trade manner, comprise a scale 5′ and a printer 5″. The shown embodiment does not comprise a brightness sensor 6. The controller 3 and memory 4 disclosed with respect to FIG. 1 are arranged in the housing 22 of the display.

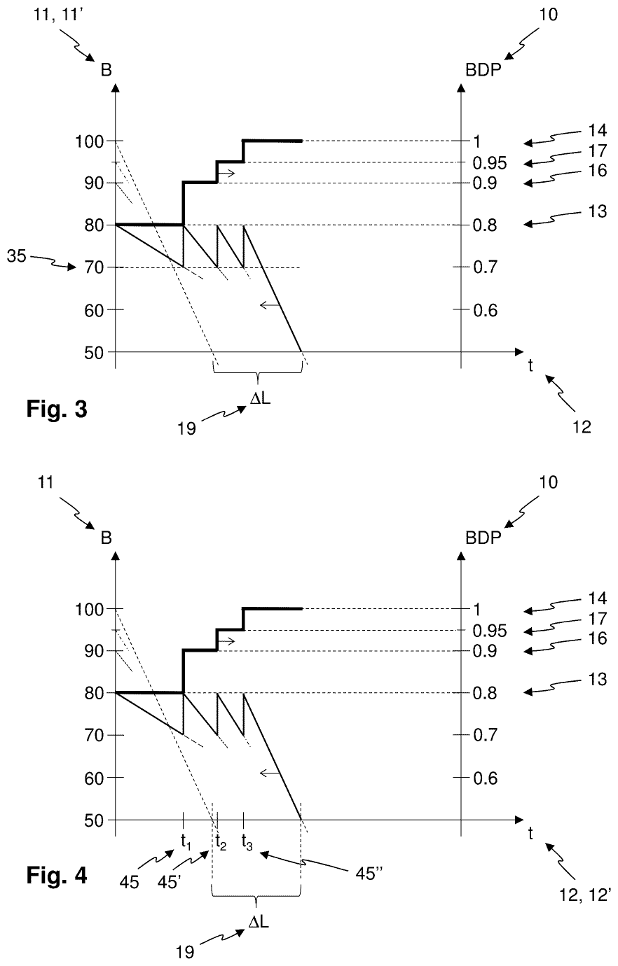

FIG. 3 visualizes what happens during execution of an exemplary embodiment of the method 100 for increasing the lifetime of a display used in retail, industry, logistic, transportation or laboratory. Therein, it is assumed that the brightness of the display 2 decreases linearly over operating time t (reference numeral 12) due to aging of the display 2, and that the slope of this linear decrease depends on the brightness dimming parameter BDP (reference numeral 10) that allows for adjustment of the brightness of the screen 21 of the display 2, in particular by adjusting the power supplied to the screen 21, and, hence, is linked to an increased temperature of the screen 21 with respect to an ambient temperature, this temperature increase being caused by operating the screen 21 with the set brightness dimming parameter 10. Such a linear dependence of the brightness on operating time 12, wherein the slope of the linear dependence depends on the brightness dimming parameter 10, is approximately true for TFT displays having an LED backlight that are operated under constant ambient (environmental) conditions, in particular constant ambient temperature, at least.

As visualized in FIG. 3, the brightness dimming parameter 10 is set at the beginning of the operating time 12 (lifetime) of the display 2, i.e., t≈0, to an initial value 13 that is below a possible maximum value 14 of the brightness dimming parameter 10 (step S1 of the corresponding method). In the embodiment shown, the initial value 13 is 0.8 times the possible maximum value 14. Consequently, the display 2 ages according to the slope attributed to the initial value 13 of the brightness dimming parameter 10. This slope is, as indicated in FIG. 3, less steep than the slope attributed to the possible maximum value 14 of the brightness dimming parameter 10. As mentioned with respect to FIG. 1, the initial value 13 is chosen such that the caused screen brightness is sufficient, but not significantly higher, for satisfying the user's needs, for fulfilling regulatory requirements (if any), and for being a good starting point for further, in particular automated, brightness adjustments (if any, e.g., adaption to changing ambient brightness).

State-of-the-art display operation methods do not comprise such a pre-setting of the brightness dimming parameter 10 or of a corresponding parameter. Rather, the basic setting of the displays is such that they are operated at the possible maximum value 14 of the brightness dimming parameter 10. Consequently, a such operated display ages according to slope attributed to the possible maximum value 14 of the brightness dimming parameter 10, this means at maximum speed.

After setting the initial value 13, the display 2 is operated with the brightness dimming parameter 10 set to the initial value. For simplicity, it is assumed in FIG. 3 that there is no adjustment of the brightness dimming parameter 10 in dependence of ambient brightness, user presence, time of the day etc. Such adjustments would result in a non-linear dependence of the brightness on operating time 12, but without causing a significant deviation from the idea behind the invention. Under the assumptions and simplifications used with respect to FIG. 3, the resulting dependence of the brightness on the operating time 12 may be visualized as a sequence of linear slopes, some of them steeper than the shown slope, i.e., the slope associated with initial value 13, (adjustment to higher screen brightness), and some of them less steep (adjustment to lower screen brightness).

As mentioned before, the brightness dimming parameter 10 set (step S1) and increased (steps S3) in agreement with the present invention may be considered as a basic brightness dimming parameter in case there is an adjustment, in particular an automated adjustment, of the brightness dimming parameter 10 in dependence of ambient brightness, user presence, time of the day etc.

In the embodiment shown in FIG. 3, a brightness 11 that is measured by a brightness sensor 6 or a brightness 11′ that is calculated by a controller 3 was determined to be the parameter that is characteristic for the aging of the display 2, and that shall be used to trigger (step S2) an increase of the (basic, as the case may be) brightness dimming parameter that is in the actual course of FIG. 3 the initial value 13.

Therefore, a brightness threshold value 35 was set. In particular, the threshold value 35 is set such that a screen brightness that may no longer satisfy the user's needs, fulfil regulatory requirements (if any), or be a good starting point for further, in particular automated, brightness adjustments (if any, e.g., adaption to changing ambient brightness) is detected. In the embodiment shown in FIG. 3, the brightness threshold value 35 was set to a measured or calculated brightness corresponding to 70% of the maximum brightness available at the beginning of the lifetime of the display (t≈0). Usually, the brightness threshold value 35 is given as an absolute value, for example in the unit cd/m², wherein the maximum brightness available at the beginning of the lifetime of the display 2 is provided by the provider of the display 2.

As soon as the measured brightness 11 or calculated brightness 11′ reaches the brightness threshold value 35 (step S2), the (basic, as the case may be) brightness dimming parameter 10 is automatically increased (step S3) for causing again a brightness of the screen 21 that is sufficient, but not significantly higher, for satisfying the user's needs, for fulfilling regulatory requirements (if any), and for being a good starting point for further, in particular automated, brightness adjustments (if any, e.g., adaption to changing ambient brightness).

In the exemplary embodiment shown in FIG. 3, the (basic, as the case may be) brightness dimming parameter 10 is therefore increased from the initial value 13 to a first increased value 16 that corresponds to 0.9 times the possible maximum value 14 in the exemplary embodiment of FIG. 3.

In the following, the display ages according to the slope attributed to the first increased value 16 of the brightness dimming parameter 10. This slope is steeper than the slope attributed to the initial value 13 of the brightness dimming parameter 10 according to which the display 2 aged so far. However, the slope is still less steep than the slope attributed to the possible maximum value 14 of the brightness dimming parameter 10. In other words, operating the display with a (basic) dimming parameter that corresponds to the first increased value 16 is still beneficial for the lifetime of the display. However, it is less beneficial as it was during operation with the basic dimming parameter being the initial value 13.

The (basic, as the case may be) brightness dimming parameter 10 is then increased further (step S3), this means to a second increased value 17, to a third increased value and so on whenever the measured brightness 11 or calculated brightness 11′ reaches again the brightness threshold value 35 (step S2) and until no further increase of the (basic) brightness dimming parameter 10 is possible because the possible maximum value 14 is reached. Only now, this means only after the (basic) brightness dimming parameter 10 was increased to the possible maximum value 14 in a step of increasing automatically the (basic) brightness dimming parameter 10 (step S3), the display 2 begins to age with the same speed as it would have if the basic brightness dimming parameter was set to the possible maximum value 14. As shown schematically in FIG. 3, operating the display 2 with a method according to the invention results in a longer lifetime 19 of the display 2, this means in a longer operating time 12 until the brightness of the screen decreased such that an end-of-life criterion is fulfilled. In the embodiment shown in FIG. 3, this criterion is a brightness reduction of 50% compared to an initial (t≈0) brightness.

It goes without saying that there may be much more steps of increasing the (basic, as the case may be) brightness dimming parameter 10 than shown in FIG. 3, in particular if the initial value and the increased values are such that only few additional aging of the display 2 is needed for causing a screen brightness that may no longer satisfy the user's needs, fulfil regulatory requirements (if any), or be a good starting point for further, in particular automated, brightness adjustments (if any, e.g., adaption to changing ambient brightness).

The amount by which the (basic, as the case may be) brightness dimming parameter 10 is automatically increased (step S3) whenever the measured brightness 11 or calculated brightness 11′ reaches the brightness threshold value 45 (step S2) may base on experience or, in case a brightness sensor 6 as disclosed exemplarily with respect to FIG. 1, on a feedback loop including the output of the brightness sensor 6.

FIG. 4 visualizes what happens during execution of another exemplary embodiment of the method 100 for increasing the lifetime of a display used in retail, industry, logistic, transportation or laboratory.

Unlike to the embodiment of FIG. 3, the operating time t, that may be the actual operating time 12 or an effective operating time 12′, was determined to be the parameter that is characteristic for the aging of the display 2, and that shall be used to trigger an increase of the (basic, as the case may be) brightness dimming parameter (step S2).

In the embodiment shown in FIG. 4, a series of threshold time values 45, 45′, 45″ was set. Again, the threshold values are set such that a screen brightness that may no longer satisfy the user's needs, fulfil regulatory requirements (if any), or be a good starting point for further, in particular automated, brightness adjustments (if any, e.g., adaption to changing ambient brightness) is detected. The concrete values of threshold time values 45, 45′, 45″ may rely on experience. It goes without saying that there may be much more threshold time values than shown in FIG. 4, in particular if the initial value and the increased values are such that only few additional aging of the display 2 is needed for causing a screen brightness that may no longer satisfy the user's needs, fulfil regulatory requirements (if any), or be a good starting point for further, in particular automated, brightness adjustments (if any, e.g., adaption to changing ambient brightness).

Unlike to the embodiment of FIG. 3, the embodiment according to FIG. 4 can provide a sufficient brightness of the screen 21 for a longer operating time without need for providing a measured or calculated brightness. However, using an effective operating time 12′ rather than an actual operating time 12, this means an operating time 12′ that considers the manner the display 2 was operated so far, may be beneficial. Therefore, the controller 3 may monitor the output of a temperature sensor 7, if any, and/or monitor, receive or retrieve at least one operation parameter of the display 2, such as the actual operating time 12, the brightness dimming parameter 10 according to which the display is operated (may differ from the basic brightness dimming parameter 10, as indicated before), a power consumption of the display 2, a resistance of the display 2, a current of the display 2 etc., as disclosed with respect to FIG. 1.

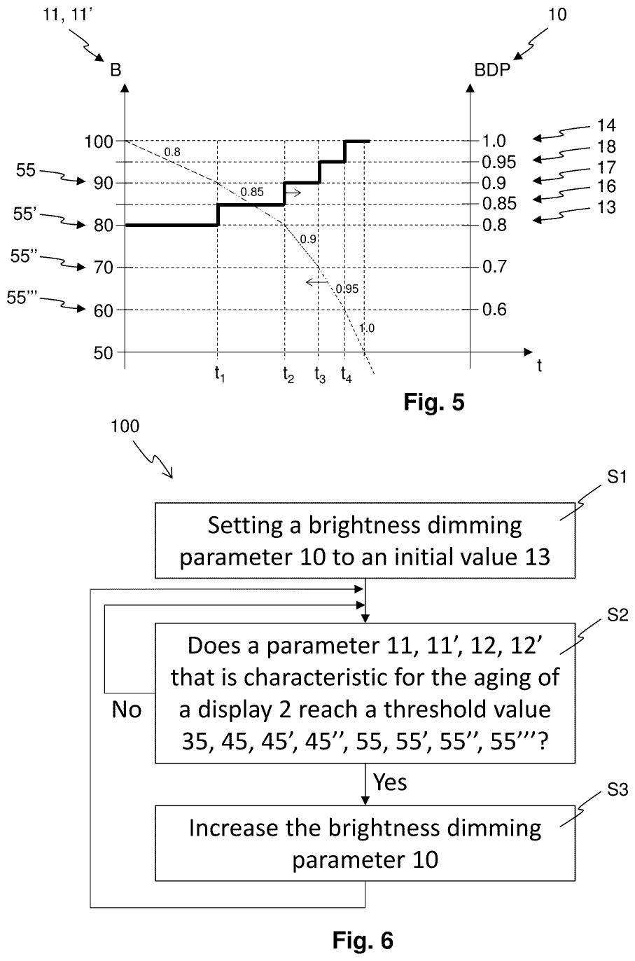

FIG. 5 visualizes what happens during execution of yet another exemplary embodiment of the method 100 for increasing the lifetime of a display 2 used in retail, industry, logistic, transportation or laboratory.

Similar to the exemplary embodiment of FIG. 3, a brightness 11 that is measured by a brightness sensor 6 or a brightness 11′ that is calculated by a controller 3 was determined to be the parameter that is characteristic for the aging of the display 2, and that shall be used to trigger (step S2) an increase of the (basic, as the case may be) brightness dimming parameter 10. Unlike to the exemplary embodiment of FIG. 3, the measured or calculated brightness is a measured or calculated remaining maximum brightness of the display 2, this means the maximum brightness that the display 2 with its current age can still provide. Consequently, the threshold value used in the exemplary embodiment of FIG. 5 is a threshold value for the remaining maximum brightness.

According to the exemplary embodiment of FIG. 5, a series of threshold values 55, 55′, 55″, 55′″ was set. In order to simplify the visualization rather than to show a technical necessity, the threshold values 55, 55′, 55″, 55′″ were set such that an increase of the (basic, as the case may be) brightness dimming parameter 10 by 0.05 (thick curve, right scale) is triggered (step S2) whenever the measured or calculated remaining maximum brightness 11, 11′ of the display 2 decreased by another 10% due to aging (thin curve, left scale). The thin curve that represents the measured or calculated remaining maximum brightness 11, 11′ in dependence on operating time t indicates the aging state of the display 2 at operation time t, wherein the same assumptions and simplifications as disclosed with respect to FIGS. 3 and 4 were made. Again, aging—and hence decrease of the measured or calculated remaining maximum brightness 11, 11′ of the display 2—is reduced at the beginning because the display 2 is run with a brightness dimming parameter 10 that corresponds to the initial value 13. The aging speed of the display 2 increases then stepwise whenever the brightness dimming parameter 10 is adjusted because a next threshold value 55, 55′, 55″, 55′″ is reached. These increases in aging speed are indicated by the slopes of the thin curve that are assumed to be constant between two consecutive steps of increasing the brightness dimming parameter 10 (step S3), and that increase after each increase of the brightness dimming parameter 10. As in FIGS. 3 and 4, it is assumed in FIG. 5 in order to simplify the visualization rather than to show a technical necessity that the initial value 13 is 0.8 times the possible maximum value 14, and that the brightness dimming parameter 10 is increased via increased values 16-18 to the possible maximum value 14. The numbers next to a segment of the thin curve indicate the brightness dimming parameter 80 to which this segment, in particular this slope, belongs. Corresponding slopes are dashed in the same manner in FIGS. 3-5.

The exemplary embodiment shown in FIG. 5 results in an increase of the brightness dimming parameter 10 at operating times t₁, t₂, t₃, t₄. These times, however, are of no relevance in the method according to the exemplary embodiment of FIG. 5. In particular, these times are no threshold values.

FIG. 6 shows a flowchart of an exemplary embodiment of a method 100 for increasing the lifetime of a display 2. The shown method comprises:
A step S1 of setting a brightness dimming parameter 10 of the display 2 to an initial value 13. This step S1 may be according to any embodiment disclosed with respect to FIGS. 1-5.
In particular, the initial value 13 is below the possible maximum value 14 of the brightness dimming parameter 10, and the step S1 of setting a brightness dimming parameter 10 of the display 2 to an initial value 13 is carried out at the beginning of the operating time 12 of the display 2.
A step S2 of determining whether the parameter 11, 11′, 12, 12′ that is characteristic for an aging of the display 2 reached a corresponding threshold value 35, 45, 45′, 45″, 55, 55′, 55″, 55′″. This step S2 may be according to any embodiment disclosed with respect to FIGS. 1-5.
If it is determined that the parameter 11, 11′, 12, 12′ that is characteristic for an aging of the display 2 reached a corresponding threshold value 35, 45, 45′, 45″, 55, 55′, 55″, 55′″, the method proceeds to a step S3 of automatically increasing the brightness dimming parameter 10. Otherwise, the step S2 of determining whether the parameter 11, 11′, 12, 12′ that is characteristic for an aging of the display 2 reached a corresponding threshold value 35, 45, 45′, 45″, 55, 55′, 55″, 55′″ is repeated after some time.
A step S3 of automatically increasing the brightness dimming parameter 10. This step S3 may be according to any embodiment disclosed with respect to FIGS. 1-5.
In particular, the method may comprise going back to the step of determining whether the parameter 11, 11′, 12, 12′ that is characteristic for an aging of the display 2 reached a corresponding threshold value 35, 45, 45′, 45″, 55, 55′, 55″, 55′″, if the brightness dimming parameter 10 after its increase did not reach yet the possible maximum value 14 of the brightness dimming parameter 10. In dependence on the concrete realization of the method, as pointed out exemplarily with respect to FIGS. 3-5, the parameter that is characteristic for an aging of the display 2 may then be compared with the same threshold value 35 (case shown in FIG. 3, parameter 11, 11′) or with another threshold value (case shown in FIGS. 4 and 5).

### REFERENCE SIGNS LIST

1 Retail, industry, logistic, transportation or laboratory device
1′ Retail weighing device
2 Display
3 Controller
4 Memory
5 Further device components
5′ Scale
5″ Printer
6 Brightness sensor
7 Temperature sensor
10 Brightness dimming parameter (BDP)
11 Measured brightness
11′ Calculated brightness
12 Actual operating time
12′ Effective operating time
13 Initial value
14 Possible maximum value
16 First increased value
17 Second increased value
18 Third increased value
19 Lifetime increase
21 Screen of the display
22 Housing of the display
35 Threshold value
45 Threshold value
45′ Threshold value
45″ Threshold value
55 Threshold value
55′ Threshold value
55″ Threshold value
55′″ Threshold value
100 Method for increasing the lifetime of a display of a weighing device

What is claimed is:

1. A method for increasing the lifetime of a display used in retail, industry, logistic, transportation or laboratory, the method comprises:
setting a brightness dimming parameter of the display to an initial value that is below a possible maximum value of the brightness dimming parameter, wherein the setting of the brightness dimming parameter of the display to the initial value is carried out at a beginning of an operating time of the display;
determining whether a parameter that is characteristic for an aging of the display reached a threshold value; and
increasing the brightness dimming parameter if the parameter that is characteristic for an aging of the display reached the threshold value.

2. The method of claim 1, wherein:
the brightness dimming parameter is increased when increasing the brightness dimming parameter to compensate for a darkening of the display due to aging.

3. The method of claim 1, wherein:
increasing the brightness dimming parameter is carried out whenever the parameter that is characteristic for an aging of the display reached the threshold value or a further threshold value.

4. The method of claim 1, wherein:
the parameter that is characteristic for an aging of the display represents a brightness of the display, wherein the parameter is derived from an output of a brightness sensor.

5. The method of claim 1, wherein:
the parameter that is characteristic for an aging of the display is a calculated brightness value.

6. The method of claim 5, wherein:
a characteristic for an operative temperature at which the display was operated during its operation is used for calculating the calculated brightness value;
the characteristic for an operative temperature is determined by monitoring an output of a temperature sensor; and
the output of the temperature sensor is characteristic for the temperature at which the display is operated or the output of the temperature sensor is processed for generating a processed output that is characteristic for the temperature at which the display is operated.

7. The method of claim 5, wherein:
a characteristic for a brightness at which the display was operated during its operation is used for calculating the calculated brightness value;
the characteristic for a brightness is determined by at least one of monitoring the brightness dimming parameter and monitoring an output of a brightness sensor; and
the output of the brightness sensor is characteristic for the brightness at which the display is operated.

8. The method of claim 1, wherein:
the parameter that is characteristic for an aging of the display represents an actual operating time of the display.

9. The method of claim 1, wherein:
the parameter that is characteristic for an aging of the display is a calculated effective operating time of the display.

10. The method of claim 9, wherein:
a characteristic for an operative temperature at which the display was operated during its operation is used for calculating the effective operating time;
the characteristic for an operative temperature is determined by monitoring an output of a temperature sensor;
the output of the temperature sensor is characteristic for the temperature at which the display is operated or wherein the output of the temperature sensor is processed for generating a processed output that is characteristic for the temperature at which the display is operated.

11. The method of claim 9, wherein:
a characteristic for a brightness at which the display was operated during its operation is used for calculating the effective operating time;
the characteristic for a brightness is determined by at least one of monitoring the brightness dimming parameter and monitoring an output of a brightness sensor; and
the output of the brightness sensor is characteristic for the brightness at which the display is operated.

12. The method of claim 1, wherein:
the display is configured for at least one of:
detecting a user presence and adjusting the brightness dimming parameter in dependence on the presence or absence of a user;
detecting an ambient brightness and adjusting the brightness dimming parameter in dependence on the detected ambient brightness; and
monitoring a time of the day and adjusting the brightness dimming parameter in dependence on the time of the day.

13. A display for use in retail, industry, logistic, transportation or laboratory, wherein the display is configured to be operated according to the method of claim 1, said display comprising a controller, or said display is configured to connect to a controller, wherein the controller is configured to execute a computer program comprising instructions, which, when the computer program is executed by the controller, causes the display to be operated according to the method of claim 1.

14. A retail, industry, logistic, transportation or laboratory device comprising the display of claim 13.

15. The retail, industry, logistic, transportation or laboratory device of claim 14 wherein:
the retail, industry, logistic, transportation or laboratory device comprises a retail weighing device.

16. A computer program comprising instructions, which, when the computer program is executed by a controller that controls a display used in retail, industry, logistic, transportation or laboratory, cause the controller to allow for operating the display according to the method of claim 1.
